(19) United States
(12) Patent Application Publication
(10) Pub. No.: US 2009/0328030 A1
(43) Pub. Date: Dec. 31, 2009

(54) INSTALLING A MANAGEMENT AGENT WITH A VIRTUAL MACHINE

(75) Inventor: Robert M. Fries, Kirkland, WA (US)

Correspondence Address: WORKMAN NYDEGGER/MICROSOFT, 1000 EAGLE GATE TOWER, 60 EAST SOUTH TEMPLE, SALT LAKE CITY, UT, 84111, US

(73) Assignee: MICROSOFT CORPORATION, Redmond, WA (US)

(21) Appl. No.: 12/163,109

(22) Filed: Jun. 27, 2008

(51) Int. Cl. G06F 9/445; G06F 15/177

(52) U.S. Cl. 717/174

(57) ABSTRACT

A management service can install one or more third-party agents and any number of customizations for an operating system/virtual machine at the same as the system/machine is installed. In one implementation, a management service places (e.g., from a remote location) an operating system/virtual machine image in a mounting location. Before installing the corresponding system (OS or virtual machine), the management service also inserts one or more third-party agents into the image, as well as any number or type of policies and customizations. The management service then directs installation of the combined image (including rules, policies, and customizations) so that the operating system, third-party agents, and provided customizations, are all installed together during the same installation process. Accordingly, the management service allows for agents to reliably and immediately begin executing with installation of the operating system/virtual machine.

### CROSS-REFERENCE TO RELATED APPLICATIONS

N/A

### BACKGROUND

### Background and Relevant Art

Conventional computer systems are now commonly used for a wide range of objectives, whether for productivity, entertainment, or the like. One reason for this is that, not only do computer systems tend to add efficiency with task automation, but computer systems can also be easily configured and reconfigured over time for such tasks. For example, if a user finds that one or more application programs are running too slowly, it can be a relatively straightforward matter for the user to add more memory (e.g., RAM), or to add or swap out one or more processors (e.g., a CPU, GPU, etc.). It may also be a straightforward matter to add or improve the current storage, or even add or replace other peripheral devices that may be used to share or handle the workload. Similarly, it can be relatively straightforward for the user to install or upgrade various application programs on the computer, including the operating system. This tends to be true in theory even on a large, enterprise scale.

In practice, however, the mere ability to add or replace physical computer hardware can often be daunting, particularly on a large scale, sometimes resulting in several hours of extra time to place and configure a new computer system (or upgrade of components). Fortunately, recent developments in virtual machine (“VM”) technology have improved or eliminated many of these types of constraints. For example, a virtual machine comprises a set of electronic files that operate as an additional, unique computer system, albeit within the confines and resource limitations of another physical host computer system.

In addition, the set of files for each virtual machine can be easily configured and re-configured in terms of resource access, and there can be several different virtual machines installed on a single physical host accessing the host's resources at different levels. Furthermore, the number of virtual machines—and the resource allocations for each virtual machine—on any given host computer system can be changed from time to time with relative ease. The users of each virtual machine, however, tend to be immune from such changes, and are generally able to access and view each different virtual machine as though it were a separate and distinct physical computer system.

Of course, one will appreciate that despite such advantages, virtual machines can come with a different set of challenges that are not seen as commonly with physical systems. Some of these challenges relate to the mechanisms for installing and managing virtual machines in the first instance. For example, in order to install a virtual machine, an administrator might use a management service to create a new virtual machine from scratch on a host system. Creating the virtual machine from scratch can include registering a new virtual machine with a local virtual machine manager commonly referred to as a hypervisor, and setting aside various storage and memory partitions for use by the virtual machine. Setting up the virtual machine can also involve installing an operating system in the allocated storage partition, and then configuring the virtual machine with a machine name, network identifier, or the like.

In addition, the system administrator may need to install one or more application programs or agents within the virtual machine for any number of purposes. For example, the administrator might desire to install one or more third-party agents to provide configuration information to the virtual machine, or to monitor how the virtual machine is performing over time. In particular, the system administrator might subsequently install a number of different agents, such as a virtual machine monitoring agent, a configuration agent, a backup agent, and a security agent, which communicate with one or more outside monitoring components, such as a remote management service operated by the system administrator.

The various agents, in turn, might be configured to report a number of different metrics related to performance of the virtual machine in a particular operating environment. For example, the system administrator might configure the given agent to routinely report usage of various memory and processing resources, as well as such resource usage by any particular application program. Specifically, the administrator might set up the rules so that the agent communicates an alert any time that a particular application is using up to 90% of the processing resources. The administrator might further set up another rule so that the agent communicates an alert any time that the virtual machine is routinely using its memory resources at a very high rate.

Thus, one will appreciate that the installation and configuration of any given virtual machine can be a fairly involved process, particularly where a large degree of configuration might be involved. To save some of the above-described steps in installing new virtual machines at a physical host, therefore, the system administrator might create several different virtual machines “images” (much like a hard disk image), and store these in a remote library. Thus, when the administrator determines that a virtual machine is needed, the administrator can simply copy a virtual machine image from the library onto the physical host. The administrator can then install the copied virtual machine image at the physical host, and subsequently perform any necessary configurations, including installing the relevant agent(s).

Unfortunately, making these various configurations, including installing the relevant agent(s), can be fairly cumbersome, particularly where a high degree of customization may be involved. This means that there is often a delay between the point at which a virtual machine is running and the virtual machine is agent(s) is/are in operation. Furthermore, installation mechanisms themselves tend to be fairly fragile. Since the virtual machine and given agent are installed on the physical host at different times, it is possible that installation of the virtual machine may result in some errors that have subsequent effects on installation of the given agent. This, in turn, can ultimately affect execution of the given agent and the reliability of the given agent to perform as expected. Unfortunately, there is little to be gained by customizing the virtual machine images stored in the library, since it is difficult to anticipate the necessary customizations for every particular operating environment, and, often times, the system administrator will prefer to use a generic virtual machine template.

The above problems tend also to be true when deploying operating system images on physical machines. With physical machines, the mechanisms are nearly identical, except that an administrator installs an operating system image (rather than a virtual machine image, as such) on a physical machine before installing the relevant agent(s) for use with the operating system. Accordingly, there are a number of difficulties with configuring and monitoring operating systems (both for virtual and physical machines) that can be addressed.

### BRIEF SUMMARY

Implementations of the present invention overcome one or more problems in the art with systems, methods, and computer program products configured to simplify installation of an operating system, such as a virtual machine operating system, and accompanying agents, such as third-party agents. In at least one implementation, for example, a management service can automatically insert an agent application into an operating system image prior to installation. The management service can further provide any required customizations or policies to the agent. The combined operating system image and inserted agent, and the provided policies can then be installed together at the same time at the appropriate installation location. Accordingly, implementations of the present invention allow for agents to begin executing immediately with installation of an instantiation of a given operating system (e.g., an instantiation of the virtual machine image), and in a much more reliable fashion.

For example, a method from the perspective of a management service of automatically loading one or more agents into an operating system image can involve sending one or more requests from a remote location to copy one or more images of one or more operating systems to a mounting location. The method can also involve identifying one or more agents to be executed in the one or more operating systems at the physical host. In addition, the method can involve identifying one or more rules for each of the one or more operating systems during execution. Furthermore, the method can involve sending one or more commands to insert at least one of the one or more agents and at least one of the one or more rules into each of the one or more operating system images at the mounting location. Still further, the method can involve sending one or more instructions to the physical host to install each operating system image for which the at least one agent and at least one rule have been inserted therein.

In addition to the foregoing, a method from the perspective of a physical host for automatically loading one or more agents into a virtual machine image before installation can involve receiving one or more requests to direct creation of one or more virtual machine images. The method can also involve receiving one or more agents and one or more rules to be inserted into the one or more virtual machine images. In addition, the method can involve executing one or more requests to insert at least one agent and at least one set of one or more rules into each of the one or more virtual machine images. Furthermore, the method can involve executing one or more requests to install the one or more virtual machine images that include the inserted at least one agent and at least one set of one or more rules, wherein installation of each virtual machine image occurs at the same time as installation of the at least one agent and at least one set of one or more rules.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

Additional features and advantages of the invention will be set forth in the description which follows, and in part will be obvious from the description, or may be learned by the practice of the invention. The features and advantages of the invention may be realized and obtained by means of the instruments and combinations particularly pointed out in the appended claims. These and other features of the present invention will become more fully apparent from the following description and appended claims, or may be learned by the practice of the invention as set forth hereinafter.

### BRIEF DESCRIPTION OF THE DRAWINGS

In order to describe the manner in which the above-recited and other advantages and features of the invention can be obtained, a more particular description of the invention briefly described above will be rendered by reference to specific embodiments thereof which are illustrated in the appended drawings. Understanding that these drawings depict only typical embodiments of the invention and are not therefore to be considered to be limiting of its scope, the invention will be described and explained with additional specificity and detail through the use of the accompanying drawings in which:

FIG. 1A illustrates an overview schematic diagram in which a management service sends one or more operating system images to a mounting location in accordance with an implementation of the present invention;

FIG. 1B illustrates an overview schematic diagram in which the management service combines the operating system image with one or more agents and configurations in accordance with an implementation of the present invention;

FIG. 3 illustrates a flow chart of methods from the perspective of the management service and physical host for inserting one or more agents and one or more management configuration policies into an operating system image for concurrent installation.

### DETAILED DESCRIPTION

Implementations of the present invention extend to systems, methods, and computer program products configured to simplify installation of an operating system, such as a virtual machine operating system, and accompanying agents, such as third-party agents. In at least one implementation, for example, a management service can automatically insert an agent application into an operating system image prior to installation. The management service can further provide any required customizations or policies to the agent. The combined operating system image and inserted agent, and the provided policies can then be installed together at the same time at the appropriate installation location. Accordingly, implementations of the present invention allow for agents to begin executing immediately with installation of an instantiation of a given operating system (e.g., an instantiation of the virtual machine image), and in a much more reliable fashion.

As will be appreciated more fully herein, therefore, implementations of the present invention allow for a number of different installation events to be coupled together prior to actual installation. For example, at least one implementation of the present invention comprises deployment of an operating system image, such as a virtual machine image, as well as insertion of appropriate management binaries. Implementations of the present invention also include mechanisms for insertion of appropriate agent configuration prior to installation. For example, a machine management service can insert a configuration document, modify a local configuration store (e.g., the registry), and establish appropriate communication and security configurations. Furthermore, implementations of the present invention include mechanisms for inserting appropriate management policy. As with inserting the agent configuration, for example, the management policy can be configured or inserted by inserting a document, modifying a local configuration store (e.g., the registry), and/or referring to an external policy store.

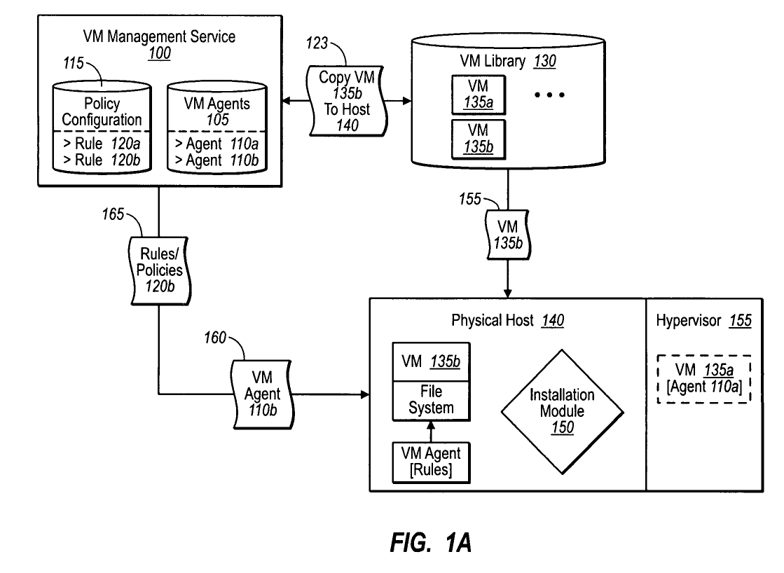

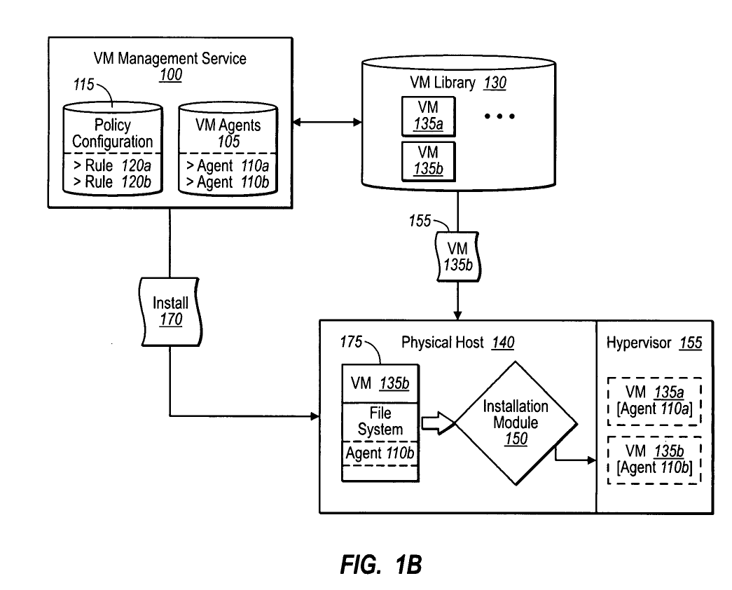

FIG. 1A illustrates an overview schematic diagram in which a management service 100 (i.e., a virtual machine management service) directs installation of one or more operating systems, and corresponding configurations at a physical host. For example, FIG. 1A illustrates an exemplary system in accordance with the present invention, which comprises a virtual machine management service 100 that is in communication with a virtual machine library 130 and physical host 135. By way of explanation, the virtual machine management service 100 comprises one or more sets of executable instructions that monitor and/or otherwise controls operations of various virtual machines for one or more physical hosts in a data center environment.

The virtual machine management service 100 is further used (whether automatically, or by direction of an administrator) or otherwise configured to install operating system images, as appropriate. Thus, the virtual machine management service 100 typically operates from a remote network location relative to the one or more mounting locations (and corresponding virtual machines) the service 100 is managing. In addition, FIG. 1A shows that virtual machine management service 100 is in communication with virtual machine library 130 to pass one or more virtual machine images to physical host 140. In general, the virtual machine images 135(a, b, etc.) comprise templates of virtual machines that have been previously configured for operating in the environment. The virtual machine images 135 can be particularly configured for use with an application program, or to take advantage of a particular physical host's resources.

As a preliminary matter, implementations of the present invention are described herein with particular reference to using a virtual machine management service (e.g., 100) to install virtual machine images from a virtual machine library at a given physical host. One will appreciate, however, that this is merely one particular implementation of the present invention directed to virtual machine image installation. For example, implementations of the present invention can also be applied to installation of other types of images with correspondingly inserted agents, such as operating system image files and corresponding agents on physical machines from a remote location. Accordingly, specific reference herein to virtual machine images (rather than generalized operating system images), virtual machine management services, and virtual machine agents, is made primarily by way of convenience in description of one possible implementation.

In any event, FIG. 1A illustrates a particular implementation in which a user or administrator desires to install a particular virtual machine at physical host 140. FIG. 1A thus shows that the management service 100 sends one or more commands 123 to the image library 130 (i.e., a virtual machine library) to copy the template or image for the given operating system 135b (in this case a specific virtual machine) to physical host 140. For example, the user or administrator specifically requested this particular template for an operating system/virtual machine 135b. Alternatively, the virtual machine management service 100 determined that this was the most appropriate template based on the particular user's request and resource requirements. In any case, FIG. 1A further shows that virtual machine library 130 communicates or otherwise transmits virtual machine 135b to a mounting location, in this case physical host 140 via communication 155.

In addition, FIG. 1A shows that virtual machine service 100 comprises one or more references to one or more virtual machine agents 105 and one or more rules or configurations that can be used to configure and/or operate the particular operating system/virtual machine. For example, FIG. 1A shows that management service 100 comprises a reference to a repository 105 of appropriate agents, as well as a reference to a repository 115 of rules and configurations. As shown, the repository 105 comprises storage for virtual machine agents 110a and 110b, while the policy/configuration repository 115 comprises storage for rules 120a and 120b.

In general, the agents 110(a, b, etc.) and policies and configurations 120(a, b, etc.) comprise a number of different instructions and rules for operating the given operating system image (e.g., VM image) in a configured manner at a mounting/installation location. For example, an exemplary virtual machine agent 110 configuration might include modifications for a virtual machine registry or configuration store, network communication configurations, and/or security protocols and configurations (e.g., x509 certificates) that are required for communication. By contrast, typical rules and policies 120 might include information that governs operations or execution of the virtual machine. For example, one set of rules might dictate that the virtual machine generate an alert when the central processing unit (CPU) is running at over 90% for more than 5 minutes. Another set of rules might dictate the ports to be used in communication. For example, one set of rules might dictate that a particular virtual machine is to communicate at least partly (or exclusively) through a particular communication port.

In addition, the types of agents that can be inserted and used to customize a given operating system/VM image can also be wide and varied. In at least one implementation, for example, the virtual machine agent 110 comprises a “monitoring agent.” Other agents 110 that can also be selected and included with installation of a given image file can include a “backup agent,” and/or a “security agent.” Thus, management service 100 can select not just one, but multiple different agents for installation with a given image.

In any event, one will appreciate that the virtual machine agents 105 and rules/policies 120 are similar to the virtual machine templates 135 in some respects, in that they provide something of a “hot standby” in terms of configurations. That is, any of the agents 110 and rules/policies 120 can be used to easily integrate with and configure virtually any of the virtual machine templates in library 130. Thus, when virtual machine management service 100 directs copying of machine given operating system image 135b to mounting location, such as physical host 140, virtual machine management service also identifies which specific rules and policies 120, as well as particular virtual machine agents 110, should be included to configure and/or customize the copied virtual machine image.

For example, FIG. 1A shows the virtual machine management service 100 determines that rules 120b and virtual machine agent 110b need to be included with virtual machine image 135b. Accordingly, FIG. 1A shows that virtual machine management service 100 sends one or more messages 160, 165 to the mounting and/or installation location, i.e., physical host 140, which messages effectively pass, transmit, or otherwise copy virtual machine agent 110b and rules 120b to physical host 140. Virtual machine management service 100 can then direct physical host 140 to combine the agent 110, rules 120, and virtual machine template 135 prior to installation.

As shown in FIG. 1B for example, virtual machine management service 100 sends one or more instructions 170 which instruct physical host 140 to combine or insert the copied agent 110b and rules 120b into the virtual machine 135b image. With respect to a MICROSOFT operating environment, for example, the virtual machine management service 100 sends one or more commands such as “copy scom.exe to c:/windows/system32” to modify the image registry so that the agent “scom.exe” runs as a service when booted. As a preliminary matter, however, one will appreciate that reference to any particular operating system or operating environment is done by way of convenience in explanation. Specifically, implementations of the present invention can be applied to any operating system or operating environment.

With reference again to the foregoing, when inserting the agent by inserting a document, the virtual machine management service 100 can also send one or more commands such as “copy scomconfig.xml to c:/windows/config.” In other cases, the insertion of the agent can also be accomplished by modifying the registry hive of the virtual machine for the case that the agent 110 configuration is contained in the registry. Agent configuration may include the name of the controlling management server and any required security information (e.g. x509 certificate) required for communication.

The virtual machine service 100 can further insert policies and rules into the virtual machine image using similar mechanisms. For example, the virtual machine service 100 could insert a document using “<firewall><port number=80>open</port></firewall>”. Alternatively service 100 could insert the rules 120b through registry manipulation. Furthermore, service 100 could insert the rules 120b through reference to an external configuration store. For example, management service 100 could insert a reference such as: “\\domain.com\managementpolicies\policy.xml.”

In any event, once all of the appropriate agent configurations and rules have been inserted into the virtual machine 135b template, this effectively creates a modified virtual machine image. Accordingly, FIG. 1B shows that physical host 140 now has a modified operating system image 175, which, in the illustrated case comprises the virtual machine image 135b from library 130 into which has been inserted agent 110b, and rules 120b. In this state, the modified operating system image 175 is now ready to be installed. Accordingly, FIG. 1B shows that virtual machine management service 100 sends one or more commands/instructions 180 to install the combined operating system image with the inserted agent(s) at physical host 140.

For example, FIG. 1B shows that physical host 140 receives instructions 180, which causes physical host 140 to process the modified image 175 via one or more installation modules 150. Installation module 150 then installs the combined virtual machine image 175 with physical host 140, so that the virtual machine 135b template, agent 110b, and rules 120b are installed at the same time. The installation thus results in a new virtual machine 135b that can be managed by hypervisor 155. (As previously mentioned, hypervisor 155 is essentially a platform for maintaining and operating virtual machines at physical host 140.) Along these lines, FIG. 1B shows that the hypervisor component 155 is now managing an operable virtual machine 135a having agent 110a installed therein, and a virtual machine 135b having agent 110b installed therein.

Accordingly, FIGS. 1A and 1B provide one or more components, schematics, and mechanisms for adding a virtual machine to a physical host and modifying that virtual machine image in one or more ways so that the virtual machine image, agents and any other customizations can all be installed at the same time. One will appreciate that this provides a number of different advantages in that the any monitoring agents, as well as any configurations, can all be immediately operable at the same time that the virtual machine is operable. Furthermore, the problems associated with separate and potentially fragile installations can be minimized since each of these components is installed at the same time during the same installation process.

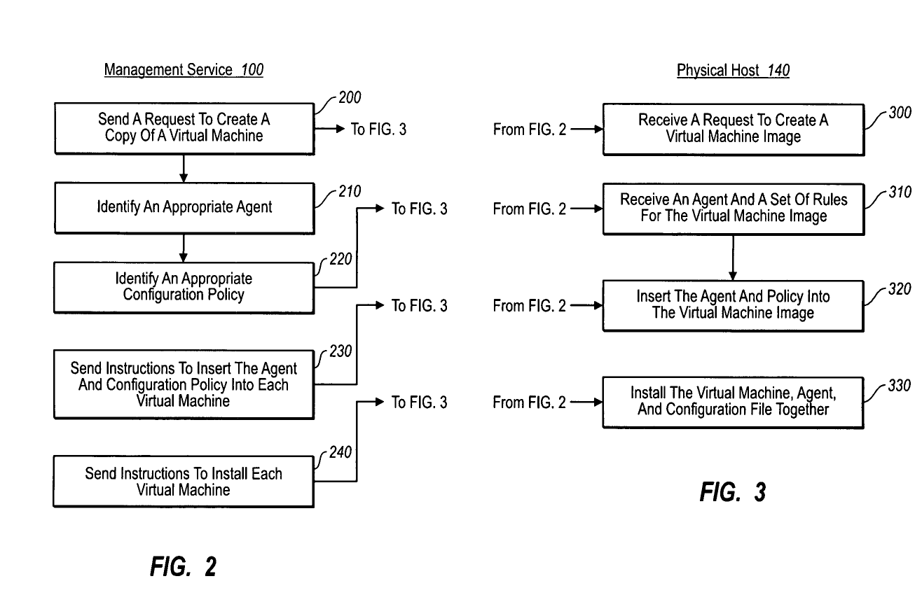

In addition to the foregoing, implementations of the present invention can also be described in terms of flow charts comprising one or more acts in a method for accomplishing a particular result. For example, FIG. 2 illustrates a flow chart from a perspective of the management service 100 for installing an operating system (e.g., for a virtual machine) image and one or more agents and rules/configurations at the same time. By contrast, FIG. 3 illustrates a method from the perspective of physical host 140 for executing installation of a virtual machine image along with one or more agents and configurations at the same time. The acts shown in FIGS. 2 and 3 are described more fully below with respect to the components and diagrams in FIGS. 1A and 1B.

For example, FIG. 2 shows that a method from the perspective of management service 100 for automatically loading one or more agents into an operating system image before installation can comprise an act 200 of sending a request to create a virtual machine. Act 200 includes sending one or more requests from a remote location to copy one or more images of one or more operating systems to a mounting location. For example, FIG. 1A shows the management service 100 sends one or more requests 123 (e.g., via, or to, virtual machine library 130) to copy or otherwise transmit operating system image 135b to a mounting and/or installation location, such as physical host 140.

FIG. 2 also shows that the method from the perspective of management service 100 can comprise an act 210 of identifying an appropriate agent. Act 210 includes identifying one or more agents to be executed into one or more operating systems at the physical host. For example, virtual machine management service 100 identifies from a request for the virtual machine, or from any number of other properties, that the copied operating system 135b should be configured or otherwise executed using agent 110b. Agent 110b, in turn, is stored in agent repository 105 at the management service 100.

In addition, FIG. 2 shows that the method from the perspective of management service 100 can comprise an act 220 of identifying an appropriate configuration policy. Act 220 includes identifying one or more configuration policies for each of the one or more operating systems during execution. For example, as shown in FIG. 1A, virtual machine management service 100 identifies a set of rules that should be used in conjunction with execution of an operating system 135b corresponding to a specific instance of a virtual machine. Management service 100, in turn, identifies that these particular rules 120b are found in repository 115.

Furthermore, FIG. 2 shows that the method from the perspective of management service 100 can comprise an act 230 of sending instructions to insert the agent and rules into each virtual machine. Act 230 includes sending one or more commands to insert at least one of the one or more agents and at least one of the one or more rules into each of the one or more operating system images at the mounting location. For example, FIG. 1B shows that virtual machine management service 100 sends one or more messages 170 to physical host 140 to insert the previously provided agent 110b and rules 120b into a file system of operating system/virtual machine 135b image.

Still further, FIG. 2 shows the method from the perspective of management service 100 can comprise an act 240 of sending instructions to install each virtual machine. Act 240 includes sending one or more instructions to the physical host to install each operating system image for which at least one agent and at least one configuration policy have been inserted therein. For example, FIG. 1B shows that management service 100 sends one or more commands/instructions 180 to install the new, modified operating system/virtual machine image 175 at physical host 140. Physical host 140 then passes the new, modified image 175 through installation module 150 to create an executable operating system or virtual machine 135b, which is configured with the agent 110b and rules 125b installed therein.

In addition to the foregoing, FIG. 3 illustrates that a method from the perspective of physical host 140 of automatically loading one or more agents into a virtual machine image before installation can comprise an act 300 of receiving a request to create a virtual machine image. Act 300 includes receiving one or more requests to direct creation of one or more virtual machine images. For example, as shown in FIG. 1A, physical host 140 receives one or more communications 155 to create or add an existing virtual machine image 135b. Such communications can include a virtual machine template template 135 stored in physical host 140 and/or from a remote location, such as virtual machine library 130.

FIG. 3 also shows that the method from the perspective of physical host 140 can comprise an act 310 of receiving an agent and a set of rules for the virtual machine image. Act 310 includes receiving one or more agents and one or more configuration policies to be inserted into the one or more virtual machine images. For example, physical host 140 receives one or more messages 160 and 165, which respectively include virtual machine agent 110b and rules 120b.

In addition, FIG. 3 shows that the method from the perspective of physical host 140 can comprise an act 320 of inserting the agent and policy into the virtual machine image. Act 320 includes executing one or more requests to insert at least one agent and at least one set of one or more rules into each of the one or more virtual machine images. For example, as shown in FIG. 1B, physical host 140 receives one or more requests from virtual machine management service 100 to insert the agent 110b and rules 120b into a file system corresponding to the virtual machine image 135b.

Furthermore, FIG. 3 shows that the method from the perspective of physical host 140 can comprise an act 330 of installing the virtual machine agent and rules together. Act 330 includes executing one or more requests to install the one or more virtual machine images with the inserted at least one agent and at least one set of one or more rules, wherein installation of each virtual machine image occurs at the same time as installation of the at least one agent and at least one set of one or more rules. For example, as shown in FIG. 1B, physical host 140 receives installation instructions 180, upon which physical host 140 passes the modified virtual machine image 175 into installation module 150. Installation module 150, in turn, creates an operating virtual machine 135b, having the agent 110b installed therein, wherein the agent 110b is also immediately operable.

Accordingly, implementations of the present invention allow an administrator to take actions that result in the instantiation of a virtual machine from an image type in an easy and efficient way. The image type references metadata (or models) that describe the workload that the virtual machine will execute. The workload definition implies or specifically declares the set of management policies that will govern its execution. The necessary management agent's binaries are automatically inserted into the image in a manner in such a way that they will be executed when the machine is booted, and the agent configuration will be automatically inserted into the image. As previously discussed, the management policy is also automatically inserted into the image. Furthermore, the appropriate management servers are notified during or after installation, so that the newly created virtual machine is known, and is under management when it is booted (e.g., in the hypervisor 155).

In addition to the foregoing, one will appreciate that the concepts and principles described herein can be modified within a number of different environments and contexts consistent with implementations of the present invention. For example, and as previously mentioned, implementations of the present invention can also be used in the context of a storage area network (SAN) deployment. In such a case, the management service 100 can be configured to modify the image file (e.g., operating system/virtual machine image) at the library server (e.g., 130).

In this example, the management service 100 can mount the SAN logical unit number (LUN) (i.e., the mounting location) on the library server 130, causing the library server 130 to copy a virtual hard disk containing the image (e.g., operating system/virtual machine) onto the LUN. The management service 100 could then modify the virtual hard disk on the LUN via the library server 130, detach the SAN LUN from the library server 130, and attach the corresponding virtual hard disk to the installation location (e.g., physical host 140). From this point, installation would proceed essentially identically as described in FIG. 1B. Thus, in this example, the mounting and installation locations would be different, while, as shown in FIGS. 1A and 1B, the mounting/installation locations are effectively the same (i.e., physical host 140).

In addition, another pattern that can be used in accordance with implementations of the present invention is to use a network boot from the library server 130. In this case, the library server 130 can also act as a SAN target (e.g. a SAN block device), such as an iSCSI target. As such, a virtual hard disk in the library server 130 may be “surfaced” as a SAN LUN. Thus, the steps to mount/install the operating system/virtual machine image can include: 1) create a new logical unit number by copying generalized image; 2) mount the logical unit number; 3) insert the selected one or more agents into operating system/virtual machine image on the logical unit number; and 4) configure the combined image/agent to boot from the logical unit number. Accordingly, one will appreciate that implementations of the present invention can be applied broadly both to local area network and storage area network environments, such that a service directions combination of image files and relevant agents before or in conjunction with remote installation thereof.

The embodiments of the present invention may comprise a special purpose or general-purpose computer including various computer hardware, as discussed in greater detail below. Embodiments within the scope of the present invention also include computer-readable media for carrying or having computer-executable instructions or data structures stored thereon. Such computer-readable media can be any available media that can be accessed by a general purpose or special purpose computer.

By way of example, and not limitation, such computer-readable media can comprise RAM, ROM, EEPROM, CD-ROM or other optical disk storage, magnetic disk storage or other magnetic storage devices, or any other medium which can be used to carry or store desired program code means in the form of computer-executable instructions or data structures and which can be accessed by a general purpose or special purpose computer. When information is transferred or provided over a network or another communications connection (either hardwired, wireless, or a combination of hardwired or wireless) to a computer, the computer properly views the connection as a computer-readable medium. Thus, any such connection is properly termed a computer-readable medium. Combinations of the above should also be included within the scope of computer-readable media.

Computer-executable instructions comprise, for example, instructions and data which cause a general purpose computer, special purpose computer, or special purpose processing device to perform a certain function or group of functions. Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

We claim:

1. At a management service in a computerized environment comprising one or more physical hosts, a method of automatically loading one or more agents into an operating system image from a remote location before installation so that the one or more agents are installed along with the operating system at the same time, comprising the acts of:
sending one or more requests from a remote location to copy one or more images of one or more operating systems to a mounting location;
identifying one or more agents to be executed in the one or more operating system at a physical host;
identifying one or more rules for each of the one or more operating systems during execution;
sending one or more commands to insert at least one of the one or more agents and at least one of the one or more rules into each of the one or more operating system images at the mounting location; and
sending one or more instructions to a physical host to install each operating system image for which the at least one agent and at least one rule have been inserted therein.

2. The method as recited in claim 1, wherein the mounting location comprises the physical host.

3. The method as recited in claim 1, wherein:
the mounting location comprises a logical unit number in a storage area network; and
the combined operating system image and at least one agent are detached from the logical unit number before installation at the physical host.

4. The method as recited in claim 1, wherein the act of sending one or more insertion commands further comprises an act of sending one or more instructions to insert a document comprising the at least one agent into a virtual machine image.

5. The method as recited in claim 1, wherein the act of sending one or more insertion commands further comprises an act of modifying a system registry for any of the one or more operating system images to reference the at least one agent.

6. The method as recited in claim 1, wherein the act of sending one or more insertion commands of sending one or more commands further comprises an act of configuring the inserted at least one agent.

7. The method as recited in claim 6, wherein the act of configuring the at least one agent further comprises an act of configuring one or more communication properties for the at least one agent.

8. The method as recited in claim 6, wherein the act of configuring the at least one agent further comprises an act of configuring security information for the at least one agent.

9. The method as recited in claim 1, wherein the act of sending one or more insertion commands further comprises an act of sending one or more instructions to insert a document comprising the at least rule into an operating system image.

10. The method as recited in claim 1, wherein the act of sending one or more insertion commands further comprises an act of modifying a system registry for any of the one or more operating system images to reference the at least one rule.

11. The method as recited in claim 10, wherein the reference to the at least one rule comprises a reference to a rule at a remote policy store.

12. The method as recited in claim 1, wherein the operating system image comprises a virtual machine image to be installed on a virtual machine host.

13. At a physical host in a computerized environment comprising one or more virtual machine management services that direct installation and management of one or more virtual machines, a method of automatically loading one or more agents into a virtual machine image before installation so that installation of the one or more agents and the virtual machine occurs at the same time, comprising the acts of:
receiving one or more requests to direct creation of one or more virtual machine images;
receiving one or more agents and one or more rules to be inserted into the one or more virtual machine images;
executing one or more requests to insert at least one agent and at least one set of one or more rules into each of the one or more virtual machine images; and
executing one or more requests to install the one or more virtual machine images that include the inserted at least one agent and at least one set of one or more rules, wherein installation of each virtual machine image occurs at the same time as installation of the at least one agent and at least one set of one or more rules.

14. The method as recited in claim 13, wherein the act of receiving one or more requests further comprises receiving one or more communications from a virtual machine library that include a copy of a virtual machine image template.

15. The method as recited in claim 14, wherein the act of executing one or more insertion requests further comprises:
receiving one or more requests to insert a document for the at least one agent into the received virtual machine image template; and
inserting the requested document into the virtual machine image.

16. The method as recited in claim 14, wherein act of executing one or more insertion requests further comprises:
receiving one or more requests to insert a reference for the at least set of one or more rules into the received virtual machine image template; and
inserting the requested reference into the virtual machine image.

17. The method as recited in claim 15, wherein act of executing one or more insertion requests further comprises receiving one or more security configurations for the at least one agent, and executing the security configurations with the inserted document or reference.

18. The method as recited in claim 15, wherein act further comprises receiving one or more communication configurations for the at least one agent, executing the communication configurations with the inserted document.

19. The method as recited in claim 16, wherein the at least one set of one or more rules comprise a reference to a network location.

20. At a virtual machine management service in a computerized environment comprising one or more physical hosts, a computer program storage product having computer executable instructions stored thereon that, when executed, cause one or more processors in a computer system to perform a method comprising:
sending one or more requests from a remote location to copy one or more images of one or more operating systems to a mounting location;
identifying one or more agents to be executed in the one or more operating system at a physical host;
identifying one or more rules for each of the one or more operating systems during execution;
sending one or more commands to insert at least one of the one or more agents and at least one of the one or more rules into each of the one or more operating system images at the mounting location; and
sending one or more instructions to a physical host to install each operating system image for which the at least one agent and at least one rule have been inserted therein.
